(19) United States
(12) Patent Application Publication
(10) Pub. No.: US 2016/0328681 A1
(43) Pub. Date: Nov. 10, 2016

(54) COMPUTERIZED CUSTOMIZATION OF DEFAULT ACTIONS

(71) Applicant: Microsoft Technology Licensing, LLC, Redmond, WA (US)

(72) Inventors: William L. Portnoy, Woodinville, WA (US); Lili Cheng, Bellevue, WA (US)

(21) Appl. No.: 14/707,222

(22) Filed: May 8, 2015

(51) Int. Cl. G06Q 10/10; G06Q 50/00

(52) U.S. Cl. CPC G06Q 10/1095; G06Q 50/01

(57) ABSTRACT

Streamlining default actions associated with features of computing systems based at least in part on training models using user behaviors and relevant attributes is described. Specifically, techniques describe streamlining availability (e.g., free/busy) information associated with electronic calendars to facilitate scheduling meetings between two or more users. Additionally, the techniques describe streamlining the functioning of reminder dialogs associated with electronic calendars. The techniques described herein are based at least in part on learning models using user behavior and relevant attributes associated with electronic calendar invitations. That is, by applying the models trained via machine learning, the techniques describe predicting whether a user is likely to respond to an electronic calendar invitation and implementing personalized default actions in an absence of user action.

### BACKGROUND

Some features of computing systems are configured to receive user action. For instance, electronic calendar invitations are configured to receive responses from users, online forms are configured to receive user input, etc. Generally, in an absence of user action, computing systems may be programmed to perform default actions with respect to the features. Programmed default actions are arbitrary actions and accordingly, can inconvenience users.

With respect to electronic invitations, an organizer of an event may send an electronic invitation to one or more invitees and the electronic invitation prompts a response from the invitees. In some examples, an invitee may respond to the electronic invitation by indicating that he or she accepts or declines the invitation or that he or she may be available. In other examples, an invitee may not respond to the electronic invitation (i.e., ignore the electronic invitation). Computing systems may be programmed to perform a programmed default action when an invitee does not respond. In some examples, the programmed default action may cause the event to be added to the invitee's electronic calendar. In other examples, the programmed default action may be to add the invitee to a guest list with other invitees who have responded that they may be attending.

In at least one example, with respect to electronic calendar invitations, an organizer of a meeting may view another user's calendar and may identify a time that the user appears to be available (e.g., free). The organizer may send the user an electronic calendar invitation for the meeting during the time the user is available (i.e., on a specified date at a specified time). If the user accepts the electronic calendar invitation, a computing system may add an indication to the user's electronic calendar indicating that the user is unavailable (e.g., busy) during the specified time on the specified date. However, if the user does not take an action with respect to the electronic calendar invitation, the computing system may be programmed to perform a programmed default action and may indicate on the user's electronic calendar that the user is tentatively unavailable at the specified time on the specified date to prevent double booking To other users, the user may appear tentatively unavailable (e.g., busy) during the specified time on the specified date. As a result, the user may appear tentatively unavailable during times that the user is not in fact tentatively unavailable. Accordingly, due to inaccuracies caused by programmed default actions, other users may not be able to use the user's calendar to effectively and efficiently schedule meetings.

Furthermore, in some examples, a reminder dialog may include a list of reminders that are associated with electronic calendar invitations. Reminders may be added to the reminder dialog in response to a user accepting an electronic calendar invitation or ignoring an electronic calendar invitation. As a specified time on a specified date associated with an electronic calendar invitation approaches, the computing system may send reminders to the user. As the user receives additional electronic calendar invitations, the user's reminder dialog may include a list of electronic calendar invitations that are not relevant to the user. Accordingly, the user may receive multiple calendar invitations for meetings that the user does not intend to attend. In some examples, a user may have so many irrelevant reminders that the user may stop paying attention to the reminders and may miss reminders for meetings that are important. As such, programmed default actions may not be useful to the user and often may cause inconvenience to the user.

### SUMMARY

This disclosure describes customizing default behaviors associated with features of computing systems based at least in part on training models based on user behaviors and relevant attributes. Specifically, techniques described herein streamline availability information (e.g., free/busy information) associated with electronic calendars to facilitate scheduling meetings between two or more users. Additionally, the techniques described herein further include learning models based at least in part on user behavior and relevant attributes associated with electronic calendar invitations. That is, by applying the models trained via machine learning, the techniques described herein predict whether a user is likely to respond to an electronic calendar invitation based on attributes associated with the electronic calendar invitation, a user who sends the electronic calendar invitation (e.g., meeting organizer), the user who receives the electronic calendar invitation, and/or the participants (e.g., other invitees) and their relationship to the user based on mailing lists and organizational charts.

The techniques described herein conserve computing resources by eliminating the back-and-forth required to perform actions and undo actions due to inaccurate or undesirable programmed default actions. Furthermore, the techniques described herein increase computer performance by streamlining a polling process where a first computing device waits for a second computing device to check for the second computing device's readiness or state. In at least one example, the first computing device may be associated with a user scheduling a meeting who looks at another user's calendar, identifies an available time, and sends an electronic calendar invitation corresponding to the available time to the other user's computing device. The first computing device may wait to receive communication from a second computing device to indicate whether the other user is available at the time requested. Accordingly, by conserving computing resources and streamlining computer performance, the techniques described herein enable more efficient scheduling and use of computing resources.

In at least one example, the techniques described herein include receiving attributes selected from a data item configured to receive user action. The data item may be associated with a programmed default action that is implemented in an absence of the user action. The techniques described herein include applying a trained model to the attributes and determining what the user action is likely to be. Based at least in part on determining that the user action is likely to be a first action, the techniques described herein include executing the first action as the default action. In the at least one example, the techniques herein further describe, based at least in part on applying the trained model to the attributes, determining that the user action is likely to be a second action and executing the second action as the default action.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a schematic diagram showing an example environment for training models from user behavior and attributes associated with data items and applying the trained models to new data items for determining how a user is likely to interact with the new data items.

FIG. 2 is a schematic diagram showing an example organizational chart visually summarizing an organizational structure and/or a hierarchy of relationships.

FIG. 3 is a schematic diagram showing an example electronic calendar invitation.

FIG. 4 is a flow diagram that illustrates a process for training models based on user behavior and attributes associated with data items and determining a set of rules from the models.

FIG. 5 is a flow diagram that illustrates a process for applying a model to new data items to determine how a user is likely to respond and executing an appropriate action.

FIG. 6 is a flow diagram that illustrates a process for applying a model to an electronic calendar invitation to determine how a user is likely to respond and causing appropriate availability information to be presented via the user's electronic calendar.

### DETAILED DESCRIPTION

This disclosure describes customizing default actions associated with various computing features based at least in part on training models using user behaviors and relevant attributes selected from data items associated with the computing features. For the purposes of this discussion, default actions are actions taken by computing programs in the absence of user action. Default actions in conventional computing systems may be programmed and are often arbitrary such that each time a decision is made by a computing device (e.g., fill or don't fill a text box on an online form, accept or decline an electronic calendar invitation, etc.), the decision is not related to any sort of user behavior or relevant attributes associated with the computing feature.

Techniques described herein utilize user behavior and attributes associated with data items configured to receive user input to predict how a user is likely to interact with the data items and determine default actions for a computing system to implement in the absence of user input. The default actions may be customized such that the default actions may be based on a prediction of how a user is likely to interact with a data item. The determined default actions may be actions that save a user time and, as described below, may be overridden by user action at any time.

In at least one example, a service provider may access data items configured to receive user input. The data items may be associated with a programmed default action that is implemented in an absence of user input. The service provider may select attributes associated with the data items and may apply a trained model to the attributes. Based at least in part on applying the trained model to the attributes, the service provider may determine what the user input is likely to be. The service provider may determine that the user action is likely to be a first action and accordingly, may execute the first action as a default action in the absence of receiving user input. In some examples, based at least in part on applying the trained model to the attributes, the service provider may determine that the user input is likely to be a second action. In such examples, the service provider may execute the second action in the absence of receiving user input. In other examples, the service provider may receive user input and, based at least in part on receiving the user input, the service provider may override the default action.

As described above, the techniques described herein conserve computing resources by eliminating the back-and-forth required to perform actions and undo actions due to inaccurate or undesirable programmed default actions. Furthermore, the techniques described herein increase computer performance by streamlining the polling process involved in scheduling meetings between two or more electronic calendar users. For the purposes of this discussion, meetings may include events, teleconferences, lectures/seminars, etc. Accordingly, by conserving computing resources and streamlining computer performance, the techniques described herein enable more efficient scheduling and computing processes.

In at least one example, techniques described herein streamline the use of electronic invitations. As described above, an organizer of an event may send an electronic invitation to one or more invitees. The electronic invitations may be sent as electronic group messages, electronic calendar invitations, etc. The electronic invitations prompt responses from the invitees. In some examples, an invitee may respond to an electronic invitation by indicating that he or she accepts, tentatively accepts (e.g., maybe), or declines the invitation. In other examples, an invitee may not respond to the electronic calendar invitation (i.e., ignore the electronic calendar invitation). Computing systems may be programmed to perform a programmed default action when an invitee does not respond. In some examples, the programmed default action may cause the event to be added to the invitee's electronic calendar. In other examples, the programmed default action may be to add the invitee to a guest list with other invitees who have tentatively accepted the electronic invitation.

The techniques described herein may include leveraging user behavior and attributes of previously received electronic invitations to learn, via machine learning, whether a user is likely to accept new electronic invitations (e.g., attend a meeting associated with the invitation) or ignore or decline new electronic invitations (e.g., not attend the meeting associated with the invitation). Accordingly, by applying the models, the computing system can predict how a user is likely to respond to an electronic invitation based on attributes associated with the electronic invitation, a user who sent the electronic invitation, the user who received the electronic invitation, and/or participants (e.g., other invitees) and their relationship to the user based on social network connections (e.g., friends, followers, etc.), address books, mailing lists, organizational charts, etc. In at least one example, the techniques described herein may include providing more accurate availability information associated with electronic calendars to streamline scheduling meetings between two or more users. Additionally, the techniques described herein further include streamlining the functioning of reminder dialogs associated with some electronic calendars. In other examples, the techniques described herein may include providing more accurate guest lists.

In addition to streamlining electronic invitations and/or calendars, techniques described herein may streamline the use of other computing features such as online forms. In at least one example, when users are presented with text boxes for completing an online form, in the absence of user action, computing systems may implement a programmed default action and automatically fill (“auto-fill”) known user information into the text boxes without user interaction with the online form. In some examples, the user may not want his or her information input into the online form. In other examples, the user may want different information input into the online form. Accordingly, the user may take an action to undo the programmed default action (e.g., delete the information). As a result, the techniques described herein may include learning which content items in an online form the user usually deletes and modifying the programmed default action to leaving that content item blank in the absence of user action (e.g., do not auto-fill). That is, the service provider may perform an action that is different from the programmed default action in the absence of user action as a result of modifying the programmed default action. Similarly, the techniques described herein may include learning which content items in an online order form the user usually does not delete and performing an action that is the same as the programmed default action to auto-fill that content item in the absence of user action.

Moreover, the techniques described herein may streamline additional or alternative computing features. In at least one example, computer programs may place log files on a user desktop as a programmed default action. A user may infrequently look at or interact with the log files. As a result, the techniques described herein may include learning that the user is not likely to look at the log files and consequently, a computing system begin removing and/or hiding the log files from the user desktop. In an additional or alternative example, a web browser may be programmed to open the new tab in a new window of the web browser in response to a user opening a new tab of a web browser and not taking any other user action. A user may consistently take a user action to return to the original tab in the original window. The techniques described herein may include learning that the user does not look at the new window when it opens and instead returns to the original window. Accordingly, the service provider may modify the programmed default action to stay on the original window instead of opening in a new window. Various other computing features may be streamlined using the systems and methods described herein.

### Illustrative Environment

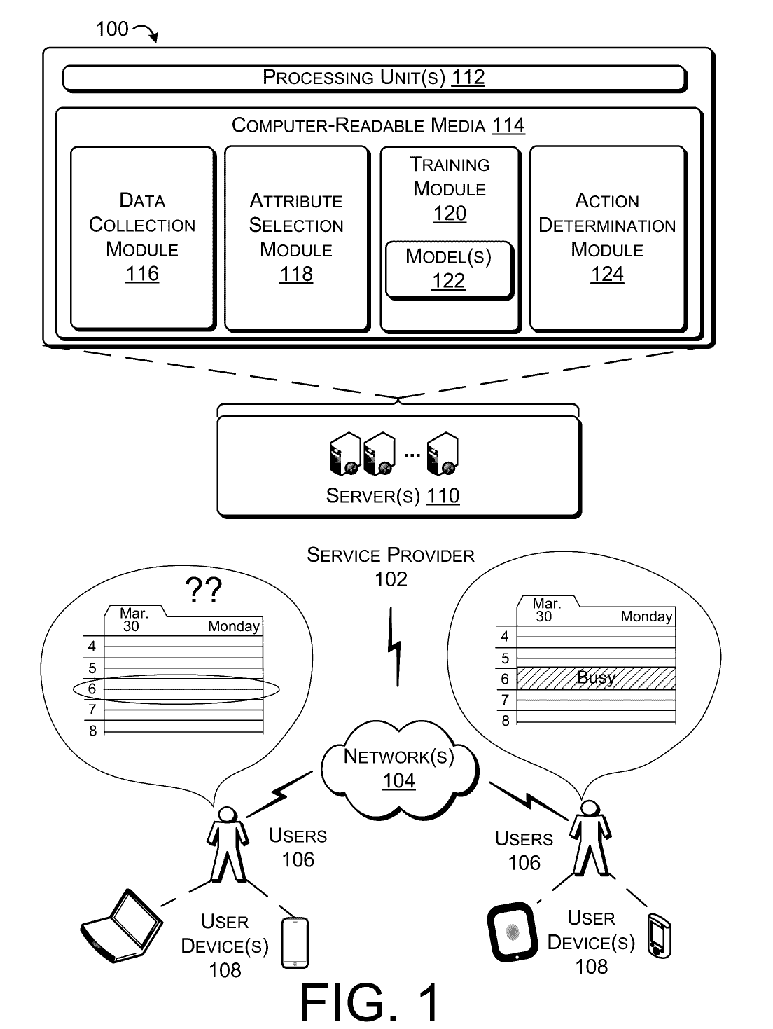

FIG. 1 is a schematic diagram showing an example environment 100 for training models from user behavior and attributes associated with data items and applying the trained models to new data items for determining how a user is likely to interact with the new data items. More particularly, the example environment 100 may include a service provider 102, one or more network(s) 104, one or more users 106, and one or more user devices 108 associated with the one or more users 106. Alternatively, or in addition, the functionality described herein can be performed, at least in part, by one or more hardware logic components such as accelerators.

The service provider 102 may be any entity, server(s), platform, etc., that enable users 106 to communicate with other users 106 via corresponding user devices 108. The service provider 102 may be implemented in a non-distributed computing environment or may be implemented in a distributed computing environment, possibly by running some modules on user devices 108 or other remotely located devices. As shown, the service provider 102 may include one or more server(s) 110, which may include one or more processing unit(s) 112 and computer-readable media 114 such as memory. In various examples, the service provider 102 may receive data associated with user behavior, select attributes from data items, and train models based on the data associated with the user behavior and attributes. Additionally, the service provider 102 may leverage the trained models to determine user actions with respect to future data items.

In some examples, the network(s) 104 may be any type of network known in the art, such as the Internet. Moreover, the user devices 108 may communicatively couple to the network(s) 104 in any manner, such as by a global or local wired or wireless connection (e.g., local area network (LAN), intranet, etc.). The network(s) 104 may facilitate communication between the server(s) 110 and the user devices 108 associated with the users 106.

In some examples, the users 106 may operate corresponding user devices 108 to perform various functions associated with the user devices 108, which may include one or more processing unit(s), computer-readable storage media, and a display. Furthermore, the users 106 may utilize the user devices 108 to communicate with other users 106 via the one or more network(s) 104.

User device(s) 108 can represent a diverse variety of device types and are not limited to any particular type of device. Examples of device(s) 108 can include but are not limited to stationary computers, mobile computers, embedded computers, or combinations thereof. Example stationary computers can include desktop computers, work stations, personal computers, thin clients, terminals, game consoles, personal video recorders (PVRs), set-top boxes, or the like. Example mobile computers can include laptop computers, tablet computers, wearable computers, implanted computing devices, telecommunication devices, automotive computers, portable gaming devices, media players, cameras, or the like. Example embedded computers can include network enabled televisions, integrated components for inclusion in a computing device, appliances, microcontrollers, digital signal processors, or any other sort of processing device, or the like.

Examples support scenarios where device(s) that may be included in the one or more server(s) 110 can include one or more computing devices that operate in a cluster or other clustered configuration to share resources, balance load, increase performance, provide fail-over support or redundancy, or for other purposes. Device(s) included in the one or more server(s) 110 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, game consoles, gaming devices, work stations, media players, digital video recorders (DVRs), set-top boxes, cameras, integrated components for inclusion in a computing device, appliances, or any other sort of computing device.

Device(s) that may be included in the one or more server(s) 110 can include any type of computing device having one or more processing unit(s) 112 operably connected to computer-readable media 114 such as via a bus, which in some instances can include one or more of a system bus, a data bus, an address bus, a PCI bus, a Mini-PCI bus, and any variety of local, peripheral, and/or independent buses. Executable instructions stored on computer-readable media 114 can include, for example, a data collection module 116, an attribute selection module 118, a training module 120 storing model(s) 122, an action determination module 124, and other modules, programs, or applications that are loadable and executable by processing units(s) 112. Alternatively, or in addition, the functionality described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Device(s) that may be included in the one or more server(s) 110 can further include one or more input/output (I/O) interface(s) coupled to the bus to allow device(s) to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like). Such network interface(s) can include one or more network interface controllers (NICs) or other types of transceiver devices to send and receive communications over a network. For simplicity, some components are omitted from the illustrated environment.

Processing unit(s) 112 can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc. In various examples, the processing unit(s) 112 may execute one or more modules and/or processes to cause the server(s) 110 to perform a variety of functions, as set forth above and explained in further detail in the following disclosure. Additionally, each of the processing unit(s) 112 may possess its own local memory, which also may store program modules, program data, and/or one or more operating systems.

In at least one configuration, the computer-readable media 114 of the server(s) 110 may include components that facilitate interaction between the service provider 102 and the users 106. The components may represent pieces of code executing on a computing device. For example, the computer-readable media 114 may include the data collection module 116, the attribute selection module 118, the training module 120 storing the model(s) 122, the action determination module 124, etc. In at least some examples, the modules (116, 118, 120, and 124) can be implemented as computer-readable instructions, various data structures, and so forth via at least one processing unit(s) 112 to configure a device to execute instructions and to perform operations implementing training models based user behavior and attributes associated with data items and applying the trained models to new data items to determine how a user 106 is likely to interact with the new data items. Functionality to perform these operations may be included in multiple devices or a single device.

Depending on the exact configuration and type of the server(s) 110, the computer-readable media 114 may include computer storage media and/or communication media. Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast, communication media may embody computer readable instructions, data structures, program modules, or other data in a modulated data signal, such as a carrier wave, or other transmission mechanism. The term “modulated data signal” means a signal that has one or more of its characteristics set or changed in such a manner as to encode information in the signal. Such signals or carrier waves, etc. can be propagated on wired media such as a wired network or direct-wired connection, and/or wireless media such as acoustic, RF, infrared and other wireless media. As defined herein, computer storage media does not include communication media. That is, computer storage media does not include communications media consisting solely of a modulated data signal, a carrier wave, or a propagated signal, per se.

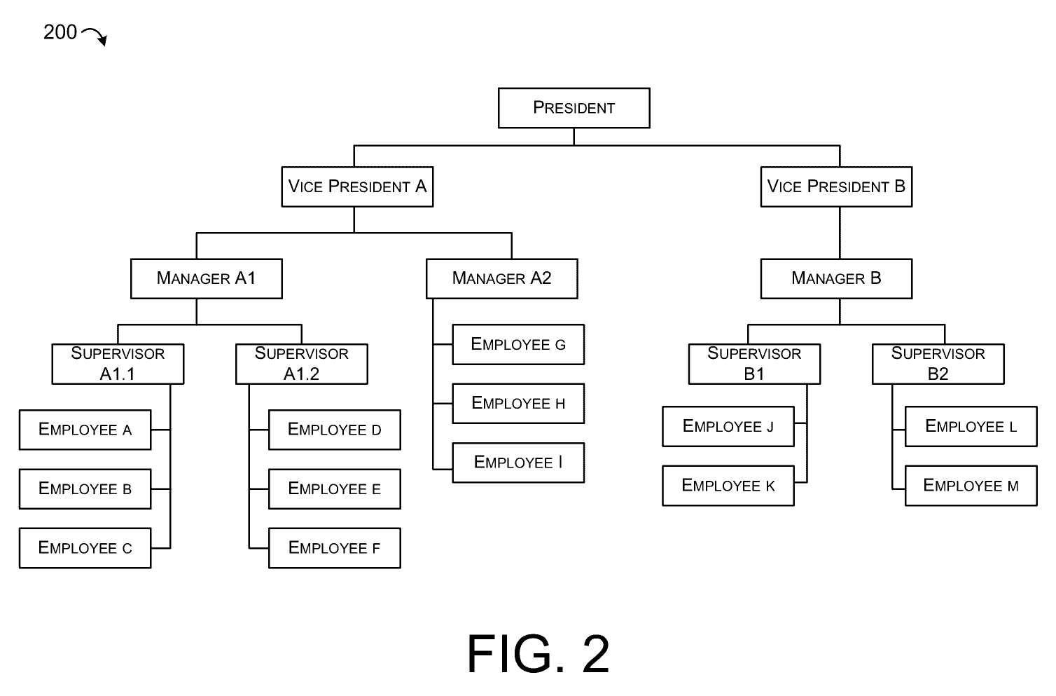

The data collection module 116 may receive and store data associated with users 106. The users 106 may include users 106 receiving electronic invitations and/or users 106 sending electronic invitations (“senders”). In at least one example, the data collection module 106 may receive organizational information associated with users 106, such as information about the users' 106 employers or other organizations that the users 106 are associated with. Organizational information may include job titles associated with users 106, departments associated with users 106, managers who oversee users 106, numbers of users 106 who directly report to other users 106, groups or teams that users 106 may be associated with, mailing lists that users 106 may belong to, etc. Organizational information may also include organizational structure and/or a hierarchy of relationships between users 106, job titles, teams, etc. within an organization. An example of an organizational chart illustrating organizational structure and/or a hierarchy of relationships is illustrated in FIG. 2. As illustrated in the organizational chart 200 of FIG. 2, Employees A, B, and C are in a same group and each employee directly reports to Supervisor A1.1. Supervisor A1.1 directly reports to Manager A1. Supervisor A1.2 directly reports to Manager A1 also and supervises Employees D, E, and F. Manager A1 and Manager A2 both report to Vice President A. All of the employees in the organizational chart 200 ultimately report to the President. The organizational chart 200 is one example of an organizational chart that illustrates organizational structure and/or a hierarchy of relationships and any other presentation or configuration may be used.

In other examples, the data collection module 116 may access data from third party sources and systems (e.g., social networks, professional networks, etc.). For instance, the data collection module 116 may access data including a user's 106 social network connections (e.g., friends, groups, circles, followers, etc.) to determine relationships between users 106.

In at least one example, the data collection module 116 may receive data associated with past user behavior and/or interactions with data items associated with various computing features. For instance, in some examples, the data collection module 116 may receive data associated with user interaction with electronic invitations. The data may indicate whether a user 106 accepted, declined, or ignored a previously received electronic invitation. Similarly, the data may indicate online forms a user 106 may have previously completed and whether the user 106 accepted auto-filled information when the user 106 submitted the online form or deleted some or all of the auto-filled information before submitting the online form. The data may indicate a frequency in which users 106 interact with data items, an amount of time that lapses between user interactions, etc. In at least one example, the data associated with the past user behavior may be collected utilizing known sensor technologies to determine whether the user 106 interacted with the data item, ignored the data item, etc. For instance, eye-sensor technologies may be utilized to determine whether a user 106 looked at an electronic calendar invitation when the user 106 received the electronic calendar invitation or whether the user 106 ignored the electronic calendar invitation. Eye-sensor technologies may also be utilized to determine a length of time that the user 106 interacts with data items.

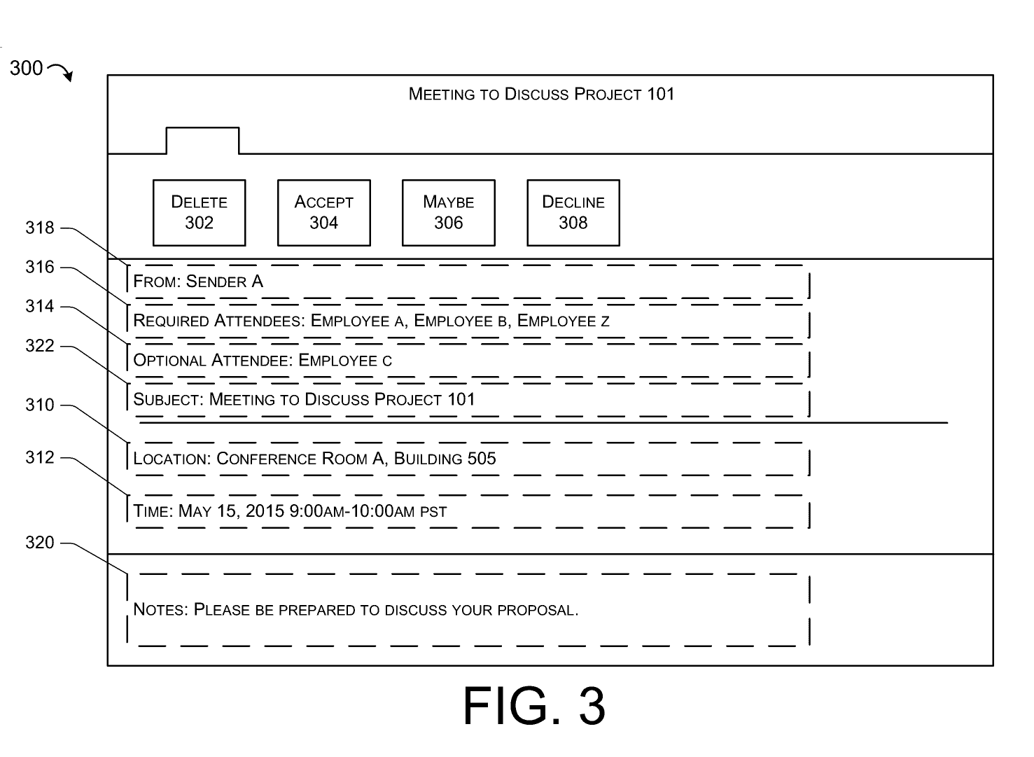

The attribute selection module 118 may select attributes from data items associated with various computing features. Attributes may represent properties associated with the data items that may be utilized for training the one or more models 122. The attributes may vary based on computing features. For instance, in at least one example, if the computing feature is an electronic calendar and the data item is an electronic calendar invitation, the attributes may include attributes associated with content in electronic calendar invitations, data associated with users 106 receiving the electronic calendar invitation, and/or data associated with users 106 sending the electronic calendar invitation, etc. FIG. 3 is a schematic diagram showing an example electronic calendar invitation 300 and various attributes that may be associated with the electronic calendar invitation. In other examples, if the data item is an online form, the attributes may include a type of input associated with a text box, contents of a text box, etc. Various other attributes may be selected from data items. In at least one example, a human or computing process may perform attribute engineering to refine the results of applying model(s) 122 as described below.

In at least one example, the attribute selection module 118 may select attributes associated with content in electronic invitations. FIG. 3 is a schematic diagram showing an example electronic calendar invitation 300. As illustrated in FIG. 3, the electronic calendar invitation may prompt a user 106 to respond by deleting 302, accepting 304, tentatively accepting (e.g., “maybe” 306), or declining 308 the electronic calendar invitation. Attributes associated with content in the electronic calendar invitations may include locations 310 included in electronic calendar invitations, times 312 included in electronic calendar invitations, etc. In some examples, attributes associated with content in the electronic calendar invitations may be based on determining whether a meeting associated with the electronic calendar invitation is an online meeting based at least in part on the electronic calendar invitation including a URL for the meeting. In at least one example, attributes associated with content in the electronic calendar invitations may include a number of participants included in electronic calendar invitations, mailing lists included in the electronic calendar invitations, a number of members included in the mailing lists, etc. Furthermore, attributes associated with content in the electronic calendar invitations may be based on whether electronic calendar invitations include a request for a response from a user 106 receiving the electronic calendar invitations, whether electronic calendar invitations are recurring, whether electronic calendar invitations have been canceled, etc.

Additionally or alternatively, attributes associated with content in the electronic calendar invitations may be based on whether a user's 106 attendance is indicated as optional 314 or required 316 in the electronic calendar invitation, which user 106 organized a meeting and/or sent the electronic calendar invitation (e.g., who the electronic calendar invitation 300 is from 318), whether the sender sent the electronic calendar invitation directly to the user 106, etc. Furthermore, in some examples, attributes associated with content in the electronic calendar invitation may be associated with the user 106 who sent the electronic calendar invitation (e.g., the organizer of the meeting). For instance, attributes associated with content in the electronic calendar invitation may be based on a department, manager, job title, number of direct reports, etc., associated with the user 106 who sent the electronic calendar invitation. In at least one example, attributes associated with content in the electronic calendar invitation may be based on determining whether a user 106 who received the electronic calendar invitation has a same job title, manager, and/or department as the user 106 who sent the electronic calendar invitation. In some examples, attributes that are associated with content in the electronic calendar invitation may be based on determining which manager, department, job title, etc. in an organizational structure and/or a hierarchy of relationships is shared between a user 106 who sent the electronic calendar invitation and the user 106 who received the electronic calendar invitation. For example, returning to FIG. 2, Employee B and Employee E share the same president (President), vice president (Vice President A), and manager (Manager A1).

Moreover, attributes associated with content in the electronic calendar invitations may include semantics associated with descriptive text in individual of the plurality of electronic calendar invitations. In at least one example, one or more text classifiers may be utilized to determine semantic meanings associated with descriptive text included in the electronic calendar invitation (e.g., description 320, subject 322, etc.). The electronic calendar invitation 300 is one example of an electronic invitation and any other presentation or configuration may be used.

Returning to FIG. 1, the training module 120 may train one or more models 122 based on the user data and the attributes selected from the data items. The training module 120 may utilize machine learning to train one or more models 122 to determine how a user 106 is likely to interact with data items. In at least one example, the training module 120 may train the one or more models 122 to determine whether a user 106 is likely to interact with data items in a same manner as a programmed default action or in a different manner. In at least some examples, the one or more models 122 may determine whether a user 106 is likely to accept an electronic invitation, consistent with a programmed default action, ignore, or decline an electronic invitation. In other examples, the one or more models 122 may determine whether a user 106 is likely to submit an online form with information that was auto-filled due to a programmed default action, or whether the user 106 is likely to delete the content that was auto-filled and submit the online form with other information. The one or more models 122 may include neural networks, decision trees, other supervised learners, etc. In at least one example, the training module 120 may store the one or more models 122.

The action determination module 124 determines default actions based on applying the one or more models 122 to new data items. In at least one example, the action determination module 124 may receive attributes associated with the new data items that may be selected by the attribute selection module 118. Based at least in part on receiving the attributes associated with the new data items, the action determination module 124 may access the one or more models 122 and may apply the one or more models 122 to the attributes to determine a user's 106 likely action with respect to the new data items. In at least one example, the action determination module 124 may utilize the one or more models 122 to determine whether a user 106 is likely to interact with data items in a same manner as a programmed default action or in a different manner. In at least some examples, the action determination module 124 may determine that a user 106 is not likely to interact with the new data items in the same manner as the programmed default action and accordingly, the action determination module 124 may perform a different action as a default action to more accurately reflect how the user 106 is likely to interact with the data items. In at least one example, the action determination module 124 may determine a set of rules based on the trained models 122.

In at least one example, the data item may be an electronic calendar invitation. The electronic calendar invitation may be configured for receiving a user response indicating that the user 106 accepts or declines the invitation. Absent user action (e.g., accepting or declining the invitation), the programmed default action may include causing an electronic calendar associated with the user 106 to be displayed indicating that the user 106 is tentatively unavailable on a specified date at a specified time associated with the electronic calendar invitation. This programmed default action may prevent double booking the user 106. Additionally, a reminder may be added to a reminder dialog associated with the electronic calendar and may cause a notification to be presented to the user 106 at a predetermined time before the specified time to remind the user 106 about the meeting. In some examples, the action determination module 124 may utilize the one or more models 122 to determine whether a user 106 is likely to accept an electronic calendar invitation, consistent with the programmed default action. In at other examples, the action determination module 124 may utilize the one or more models 122 to determine whether the user 106 is not likely to accept an electronic calendar invitation. The action determination module 124 may implement the appropriate action in an absence of user action.

In another example, the data item may be an electronic invitation sent via a group message. The electronic invitation may be configured for receiving a user response indicating that the user 106 accepts, tentatively accepts, or declines the invitation. Absent user action (e.g., accepting or declining the invitation), the programmed default action may include causing adding the user 106 to a guest list with other users 106 who have tentatively accepted the electronic invitation. This programmed default action may provide the sender with a maximum number of possible attendees. The action determination module 124 may utilize the one or more models 122 to determine whether a user 106 is likely to accept an electronic invitation, consistent with the programmed default action. In at other examples, the action determination module 124 may utilize the one or more models 122 to determine whether the user 106 is not likely to accept the electronic invitation. The action determination module 124 may implement the appropriate action in an absence of user action. For instance, if the action determination module 124 determines that the user 106 is not likely to accept the electronic invitation, the action determination module 124 may add the user 106 to a guest list of users 106 who have declined the electronic invitation. On the other hand, the action determination module 124 may determine that the user 106 is likely to accept the electronic invitation and may add the user 106 to a guest list of users 106 who have accepted the electronic invitation.

In an alternative or additional example, the data item may be an online form including a plurality of text boxes. The online form may be configured for a user 106 to enter information into individual text boxes of the plurality of text boxes. In an absence of user action, the service provider 102 may auto-fill information into the individual text boxes (e.g., the programmed default action). In some examples, the action determination module 124 may utilize the one or more models 122 to determine that a user 106 is likely to submit an online form with information that was auto-filled due to the programmed default action. In such examples, the action determination module 124 may auto-fill the information in the online form. In other examples, the action determination module 124 may utilize the one or more models 122 to determine that a user 106 is likely to submit an online form with information that is different from the auto-filled information. In such examples, the action determination module 124 may not auto-fill the information.

### Example Processes

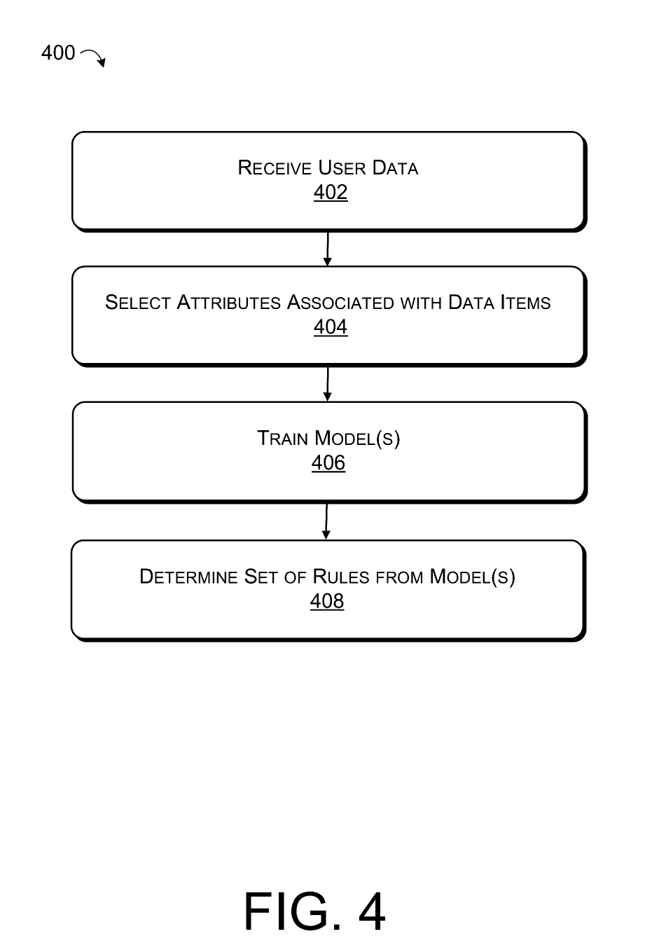

The processes described in FIGS. 4-6 below are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 4 is a flow diagram that illustrates a process 400 for training models based on user behavior and attributes associated with data items and determining a set of rules from the models.

Block 402 illustrates receiving user data. As described above, the data collection module 116 may receive and store data associated with users 106. The data may include organizational data, such as a user's 106 job title, manager, department, etc. Additionally, the data may include data associated with user behavior. In at least one example, the data may include data associated with previous user 106 interactions with data items. In some examples, the data may indicate whether a user 106 accepted individual electronic calendar invitations, whether the user 106 declined individual electronic calendar invitations, and whether the user 106 ignored individual electronic calendar invitations. In at least one example, the data may indicate whether a user 106 took some action with respect to the data items (e.g., accepted or declined individual electronic calendar invitations) or did not interact with the data item (e.g., ignored the individual electronic calendar invitation) and, accordingly, accepted the programmed default action. In other examples, the data may include whether a user 106 submitted an online form without correcting information that was auto-filled, whether a user 106 edited information that was auto-filled before submitting an online form, etc.

Block 404 illustrates selecting attributes associated with data items. As described above, the attribute selection module 118 may select one or more attributes corresponding to the data items. In at least one example, attribute selection module 118 may select one or more attributes associated with the content in the electronic calendar invitations, data associated with a user 106 receiving the electronic calendar invitations, and/or data associated with users 106 who sent electronic calendar invitations.

Block 406 illustrates training model(s) 122. The training module 120 may train the one or more models 122 based on the user data and the attributes selected by the attribute selection module 118. The one or more models 122 may determine how a user 106 is likely to interact with the data items and may execute a default action that is customized based on how the user 106 is likely to interact in an absence of user action. The one or more models 122 may include neural networks, decision trees, and other supervised learners. A non-limiting example of a trained decision tree is illustrated in Decision Tree 1 below.

Decision Tree 1

UserRequiredAttendee = True
| OrganizerSameJobTitle = True
| | OrganizerSameManager = Manager A: False (1.0)
| | OrganizerSameManager = Manager B: True (2.0)
| | OrganizerSameManager = Manager C: False (0.0)
| | OrganizerSameManager = Manager D: False (0.0)
| OrganizerSameJobTitle = False
| | IsResponseRequested = True
| | | IsRecurring = True
| | | | OrganizerSameDepartment = True
| | | | | OrganizerDirectReports <= 1: False (1.0)
| | | | | OrganizerDirectReports > 1: True (2.0)
| | | | OrganizerSameDepartment = False: False (3.0)
| | | IsRecurring = False: True (97.0/18.0)
| | IsResponseRequested = False
| | | OrganizerSameDepartment = True: True (1.0)
| | | OrganizerSameDepartment = False: False (16.0)
UserRequiredAttendee = False
| UserOptionalAttendee = True: True (17.0/6.0)
| UserOptionalAttendee = False: False (813.0/6.0)

Decision Tree 1 is based at least in part on user data and attributes selected from a plurality of electronic calendar invitations associated with the user 106. In Decision Tree 1, if the user 106 received an electronic calendar invitation that named the user 106 as a required attendee, the electronic calendar invitation was from another user 106 (e.g., sender, organizer, etc.) with a same job title as the user 106, and the sender's manager was Manager B, the user 106 tended to accept the electronic calendar invitation. However, the user 106 tended not to accept (i.e., ignored or declined the electronic calendar invitation) the electronic calendar invitation when the sender's manager was Manager A, Manager C, or Manager D, despite having been named as a required attendee in the electronic calendar invitation and having the same job title as the sender. Accordingly, the model 122 may learn that when the user 106 receives an electronic calendar invitation that names the user 106 as a required attendee, the electronic calendar invitation is from a sender with a same job title as the user 106, and the sender's manager is Manager B, the user 106 is likely to accept the electronic calendar invitation. Moreover, the model 122 may learn that when the user 106 receives an electronic calendar invitation that names the user 106 as a required attendee, the electronic calendar invitation is from a sender with a same job title as the user 106, and the sender's manager is Manager A, Manager C, or Manager D, the user 106 is not likely to accept the electronic calendar invitation.

Additionally, if the user 106 (e.g., receiving user 106) received an electronic calendar invitation that named the user 106 as a required attendee, the electronic calendar invitation was from another user 106 (e.g., sender, organizer, etc.) with a different job title as the user 106, the electronic calendar invitation indicated that a response is requested, the electronic calendar invitation is for a recurring meeting, and the sender is within a same organizational department as the user 106, the user 106 tended to accept the electronic calendar invitation when the sender had more than one employee directly reporting to him or her. On the other hand, if the user 106 received an electronic calendar invitation that named the user 106 as a required attendee, the electronic calendar invitation was from a sender with a different job title as the user 106, the electronic calendar invitation indicated that a response is requested, the electronic calendar invitation is a recurring meeting, and the sender is within a same organizational department as the user 106, the user 106 tended to decline or ignore (i.e., not accept) the electronic calendar invitation when the sender had one or no employees who report directly to him or her. Accordingly, the model may learn that if the user 106 (e.g., receiving user 106) receives an electronic calendar invitation that names the user 106 as a required attendee, the electronic calendar invitation is from a sender (e.g., organizer) with a different job title as the user 106, the electronic calendar invitation indicates that a response is requested, the electronic calendar invitation is a recurring meeting, and the sender is within a same organizational department as the user 106, the user 106 is likely to accept the electronic calendar invitation when the sender has more than one employee who directly reports to him or her and decline the electronic calendar invitation when the sender has one or fewer employees who directly report to him or her.

Furthermore, if the user 106 (e.g., receiving user 106) received an electronic calendar invitation that named the user 106 as a required attendee, the electronic calendar invitation was from another user 106 (e.g., sender, organizer, etc.) with a different job title as the user 106, the electronic calendar invitation indicated that a response is requested, the electronic calendar invitation was a recurring meeting, and the sender is in a different organizational department as the user 106, the user 106 tended to decline or ignore (i.e., not accept) the electronic calendar information. As such, the one or more models 122 may learn that if the user 106 receives an electronic calendar invitation that named the user 106 as a required attendee, the electronic calendar invitation is from a sender with a different job title as the user 106, the electronic calendar invitation indicated that a response is requested and is a recurring meeting, and the sender is in a different organizational department as the user 106, the user 106 is likely to decline the electronic calendar information. In another example, if the user 106 received an electronic calendar invitation that named the user 106 as a required attendee, the electronic calendar invitation was from another user 106 (e.g., sender, organizer, etc.) with a different job title as the user 106, the electronic calendar invitation indicated that a response is requested, and the electronic calendar invitation is not a recurring meeting, the user 106 tended to accept the electronic calendar invitation. Accordingly, the one or more models 122 may learn that if the user 106 receives an electronic calendar invitation that names the user 106 as a required attendee, the electronic calendar invitation is from a sender with a different job title as the user 106, the electronic calendar invitation indicates that a response is requested, and the electronic calendar invitation is not a recurring invitation, the user 106 is likely to accept the electronic calendar invitation.

In another example, if the user 106 (e.g., receiving user 106) received an electronic calendar invitation that named the user 106 as a required attendee, the electronic calendar invitation was from another user 106 (e.g., sender, organizer, etc.) with a different job title as the user 106, and the electronic calendar invitation indicated that a response is not requested, the user 106 tended to decline or ignore (i.e., not accept) the electronic calendar information unless the sender was in a same department as the user 106. Accordingly, the one or more models 122 may learn that if the user 106 (e.g., receiving user 106) receives an electronic calendar invitation that names the user 106 as a required attendee, the electronic calendar invitation is from a sender with a different job title as the user 106, the electronic calendar invitation indicates that a response is not requested, the user 106 is likely to decline the electronic calendar information unless the sender is from the same department as the user 106. Furthermore, if the user 106 received an electronic calendar invitation that did not name the user 106 as a required attendee but named the user 106 as an optional attendee, the user 106 tended to accept the electronic calendar invitation. However, if the user 106 received an electronic calendar invitation that did not name the user 106 as a required attendee and did not name the user 106 as an optional attendee, the user 106 tended to decline or ignore (i.e., not accept) the electronic calendar invitation. Accordingly, the one or more models 122 may learn that the user is likely to decline an electronic calendar invitation that does not name the user 106 as a required attendee or an optional attendee and is likely to accept an electronic calendar invitation that does not name the user 106 as a required attendee but that names the user 106 as a required attendee.

Block 408 illustrates determining a set of rules from the model(s) 122. The action determination module 124 may determine a set of rules based on the one or more models 122. In at least one example, the action determination module 124 may determine a set of rules for determining how the action determination module 124 is to respond to new electronic calendar invitations absent user interaction. In some examples, the action determination module 124 may determine that the user 106 is likely to accept a future electronic calendar invitation and may update an electronic calendar to indicate that the user 106 is tentatively unavailable on a specified date at a specified time associated with the new electronic calendar invitation and add a reminder to the reminder dialog. In other examples, the action determination module 124 may determine that the user 106 is not likely to accept the future electronic calendar and may update the electronic calendar to be displayed without any indication indicating that the user 106 is tentatively unavailable on the specified date at the specified time (e.g., the action determination module 124 may not take any action and the user 106 may appear available on his or her electronic calendar). Furthermore, the action determination module 124 may cancel or remove any reminders associated with the electronic calendar invitation from the reminder dialog. Non-limiting examples of specific rules that may be determined by the action determination module 124 based on the one or more models 122 are described above. Decision Tree 1 is one example of a model 122 that may be trained from user behavior and attributes selected from data items and other decision trees and/or models may be used.

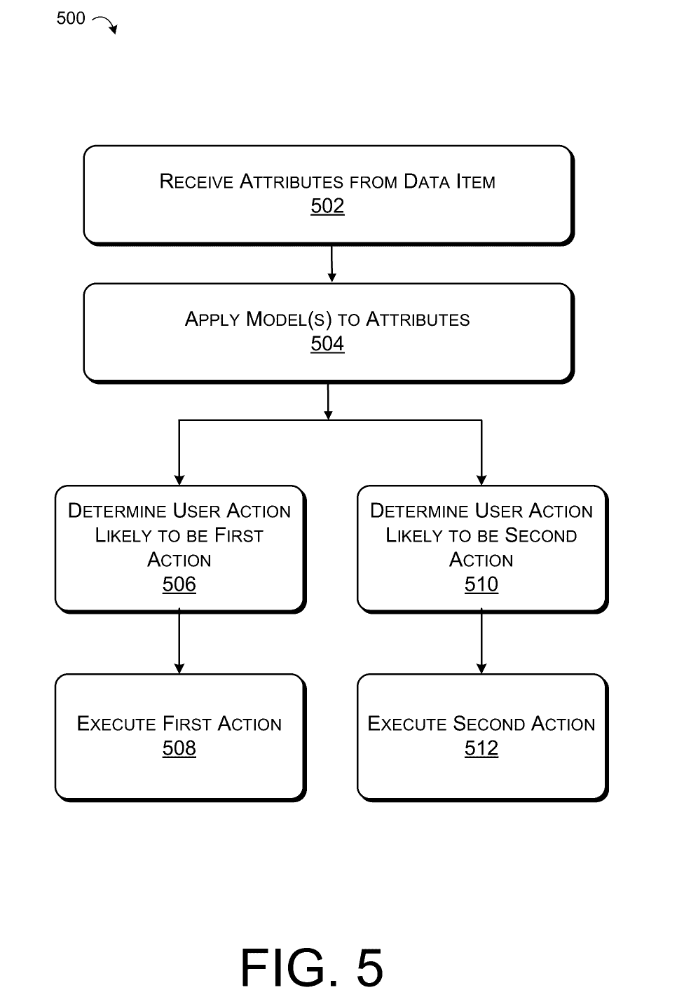

FIG. 5 is a flow diagram that illustrates a process 500 for applying a model 122 to new data items to determine how a user 106 is likely to respond and executing an appropriate action.

Block 502 illustrates receiving attributes from data items. The attribute selection module 118 may select attributes from the data items, as described above. In at least one example, the attributes may correspond to one or more of content in electronic calendar invitations, data associated with users 106 receiving the electronic calendar invitations, or data associated with users 106 who send the electronic calendar invitations. The action determination module 124 may receive the attributes from the attribute selection module 118.

Block 504 illustrates applying model(s) 122 to the attributes. The action determination module 124 may access the one or more models 122 from the training module 120 and may apply the one or more models 122 to the attributes to predict how a user 106 is likely to interact with the data items. In at least some examples, the action determination module 124 may determine that the user input is likely to be a first action, as illustrated in block 506. The first action may be a same action as a programmed default action. Accordingly, the action determination module 124 may execute the first action as a default action in an absence of user action, as illustrated in block 508.

In at least one example described above, the data item may be an electronic calendar invitation. The electronic calendar invitation may be configured such that a user 106 may accept or decline the invitation. Absent user action (e.g., accepting or declining the invitation), the programmed default action may include updating an electronic calendar associated with the user 106 to indicate that the user 106 is tentatively unavailable on a specified date at a specified time associated with the electronic calendar invitation. This programmed default action may prevent double booking the user 106. Additionally, a reminder may be added to a reminder dialog associated with the electronic calendar and may cause a notification to be presented to the user 106 at a predetermined time before the specified time to remind the user 106 about the meeting. In at some examples, the action determination module 124 may utilize the one or more models 122 to determine that a user 106 is likely to accept an electronic calendar invitation (e.g., determine that the user action is likely to be a first action), consistent with the programmed default action, as illustrated in block 506. Accordingly, the action determination module 124 may perform the first action (e.g., present the user's 106 electronic calendar indicating that the user 106 is tentatively unavailable) as a default action.

In at least an alternative or additional example described above, the data item may be an online form including a plurality of text boxes. The online form may be configured for a user 106 to enter information into individual text boxes of the plurality of text boxes. In an absence of user action, the service provider 102 may auto-fill information into the individual text boxes (e.g., the programmed default action). In some examples, the action determination module 124 may utilize the one or more models 122 to determine whether a user 106 is likely to submit an online form with information that was auto-filled due to the programmed default action (e.g., determine that the user action is likely to be a first action), as illustrated in block 506. In such examples, the action determination module 124 may execute the first action (e.g., auto-fill the information in the online form), as illustrated in block 508.

In other examples, the action determination module 124 may determine that the user input is likely to be a second action that is different from the programmed default action, as illustrated in block 510. Accordingly, the action determination module 124 may execute a second action as a default action in an absence of user input, as illustrated in block 512. In at least one example as described above, the action determination module 124 may utilize the one or more models 122 to determine that the user 106 is not likely to accept an electronic calendar invitation. Accordingly, the action determination module 124 may execute a second action other than the programmed default action (e.g., present the user's 106 electronic calendar indicating that the user 106 is available), as illustrated in block 512. In the alternative or additional example described above, the action determination module 124 may utilize the one or more models 122 to determine that a user 106 is likely to submit an online form with information that is different from the auto-filled information. In such examples, the action determination module 124 may execute a second action other than the programmed default action (e.g., may not auto-fill the information), as illustrated in block 512.

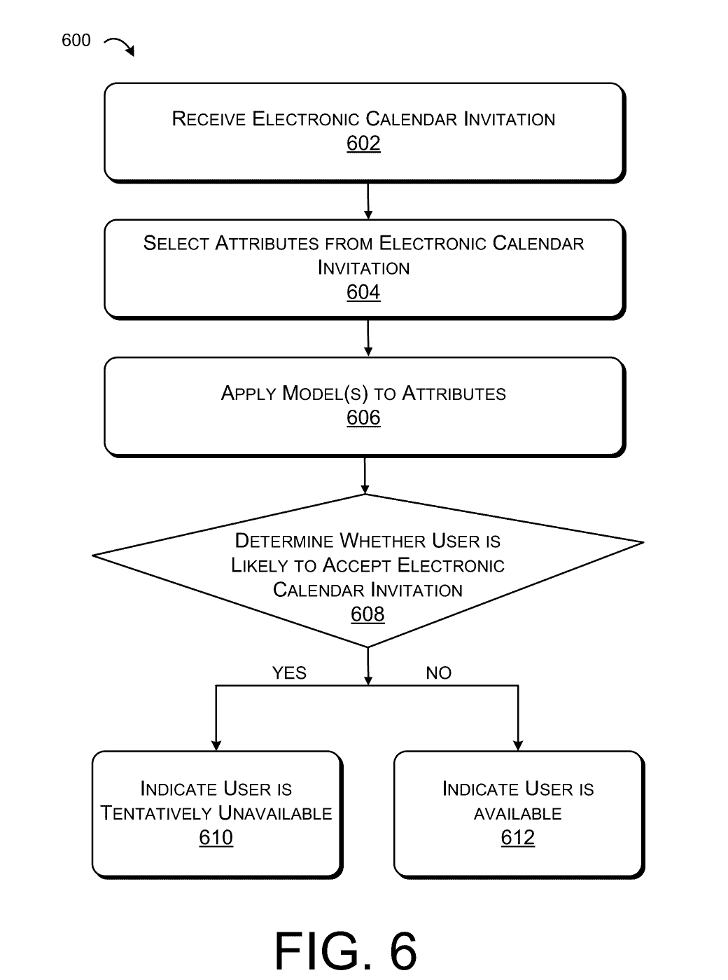

FIG. 6 is a flow diagram that illustrates a process 600 for applying a model 122 to an electronic calendar invitation to determine how a user 106 is likely to respond and causing appropriate availability information to be presented via the user's 106 electronic calendar.

Block 602 illustrates receiving an electronic calendar invitation. The electronic calendar invitation may be for a meeting on a specified date at a specified time. The electronic calendar invitation may be associated with a programmed default action such that in the absence of user action, the action determination module 124 may cause an indication to be displayed on an electronic calendar that is associated with the user 106 indicating that the user 106 is tentatively unavailable on the specified date at the specified time. Moreover, the service provider 102 may add a reminder to a reminder dialog to causing a notification to be presented to the user 106 at a predetermined time before the specified time to remind the user 106 about the meeting.

Block 604 illustrates selecting attributes from the electronic calendar invitation. The attribute selection module 118 may select attributes from the electronic calendar invitation. In at least one example, the attributes may correspond to one or more of content in electronic calendar invitations, data associated with users 106 receiving the electronic calendar invitations, and/or data associated with users 106 who send the electronic calendar invitations, as described above.

Block 606 illustrates applying the model(s) 122 to the attributes. The action determination module 124 may access the one or more models 122 from the training module 120 and may apply the one or more models 122 to the attributes to determine whether a user 106 is likely to accept the electronic calendar invitation, as illustrated in decision block 608. In at least one example, based at least in part on determining that the user 106 is likely to accept the electronic calendar invitation, the action determination module 124 may cause an indication indicating that the user 106 is tentatively unavailable to be added to the user's 106 electronic calendar on the specified date at the specified time, as illustrated in block 610. Additionally, in at least some examples, the action determination module 124 may add a reminder to a reminder dialog associated with the electronic calendar and may cause a notification to be presented to the user 106 at a predetermined time before the specified time to remind the user 106 about the meeting.

In at least one example, the user 106 may see a first view of the indication indicating that the user 106 is tentatively unavailable and other users 106 with whom the user 106 shares his or her electronic calendar may see a second view of the indication indicating that the user 106 is tentatively unavailable. In some examples, the second view of the indication may include less information than the first view. For instance, the first view may include details associated with the electronic calendar invitation and associated meeting.

In other examples, the action determination module 124 may determine that the user 106 is not likely to accept the electronic calendar invitation (e.g., the user 106 is likely to reject the electronic calendar invitation). In such examples, the action determination module 124 may cause the user's 106 electronic calendar to be presented indicating that the user 106 is available, as illustrated in block 612. That is, the action determination module 124 may not add any indication to the user's 106 electronic calendar and the user's electronic calendar may reflect that the user 106 is available during the specified time on the specified date. Additionally, the action determination module 124 may cancel a notification corresponding to the electronic calendar invitation that is to be presented to the user 106 at a predetermined time before the specified time to remind the user 106 about the meeting.

In at least one example, the user 106 may see a first view of the indication indicating that the user 106 is tentatively unavailable and other users 106 with whom the user 106 shares his or her electronic calendar may see a second view of the indication indicating that the user 106 is available. In some examples, the second view of the indication may include less information than the first view. For instance, the first view may include details associated with the electronic calendar invitation and associated meeting.

In at least one example, user action may override any default action implemented by the action determination module 124. For instance, the action determination module 124 may determine that the user 106 is likely to accept an electronic calendar invitation. However, the user 106 may decline the electronic calendar invitation. Accordingly, the action determination module 124 may cause the user's 106 electronic calendar to be presented indicating that the user 106 is available (e.g., delete the indication indicating that the user 106 is unavailable). Additionally, the action determination module 124 may cancel a notification corresponding to the electronic calendar invitation that is to be presented to the user 106 at a predetermined time before the specified time to remind the user 106 about the meeting. Alternatively, the action determination module 124 may determine that the user 106 is not likely to accept an electronic calendar invitation. However, the user 106 may accept the electronic calendar invitation. Accordingly, the action determination module 124 may cause an indication indicating that the user 106 is not available to be presented on the user's 106 electronic calendar. Additionally, the action determination module 124 may send a notification corresponding to the electronic calendar invitation that is to be presented to the user 106 at a predetermined time before the specified time to remind the user 106 about the meeting. In at least one example, hard coded rules input by user 106 may also override any default action implemented by the action determination module 124.

A. A system comprising: one or more processors; and memory storing one or more modules that are executable by the one or more processors to perform operations comprising: receiving an electronic calendar invitation for a meeting at a specified time; determining that a user is likely to accept the electronic calendar invitation based at least in part on one or more trained models; and presenting an electronic calendar that is associated with the user indicating that the user is tentatively unavailable on the specified date at the specified time.

B. The system as paragraph A recites, wherein the one or more modules are executable by the one or more processors to further perform operations comprising causing a notification to be presented at a predetermined time before the specified time.

C. The system as either paragraph A or B recites, wherein the one or more modules are executable by the one or more processors to further perform operations comprising: determining that the user is not likely to accept the electronic calendar invitation based at least in part on the one or more trained models; and presenting the electronic calendar indicating that the user is available at the specified time.

D. The system as paragraph C recites, wherein the one or more modules are executable by the one or more processors to further perform operations comprising canceling a notification corresponding to the electronic calendar invitation that is to be presented at a predetermined time before the specified time.

E. The system as any of paragraphs A-D recite, wherein the one or more modules are executable by the one or more processors to further perform operations comprising training the one or more trained models based at least in part on past behaviors of the user and one or more attributes.

F. The system as paragraph E recites, wherein the one or more attributes correspond to one or more of content in the plurality of electronic calendar invitations, data associated with the user, or data associated with other users who sent the plurality of electronic calendar invitations.

G. The system as paragraph E recites, wherein: the one or more attributes correspond to content in the plurality of electronic calendar invitations; and the content in the plurality of electronic calendar invitations comprises one or more of: a location included in individual ones of the plurality of electronic calendar invitations; a time included in individual ones of the plurality of electronic calendar invitations; participants included in individual ones of the plurality of electronic calendar invitations; and descriptive text in individual ones of the plurality of electronic calendar invitations.

H. The system as paragraph E recites, wherein: the one or more attributes correspond to data associated with other users who sent the plurality of electronic calendar invitations; and the data associated with the other users comprises at least one of: departments of the other users; job titles of the other users; managers of the other users; or numbers of employees who directly report to the other users.

I. The system as paragraph E recites, wherein: the one or more attributes correspond to data associated with the user and data associated with other users who sent the plurality of electronic calendar invitations; and the data associated with the user and the data associated with the other users is used to train the one or more trained models based at least in part on identifying at least one of a same department, same job title, or same manager between the user and the other users.

J. A computer-implemented method comprising: receiving attributes selected from a data item configured to receive user action, the data item associated with a default action that is implemented in an absence of the user action; applying a trained model to the attributes; based at least in part on applying the trained model to the attributes, determining what the user action is likely to be; and based at least in part on the determining, executing the default action in the absence of the user action.

K. The computer-implemented method as paragraph J recites, further comprising: based at least in part on applying the trained model to the attributes, determining that the user action is likely to be a first action; and executing the first action as the default action.

L. The computer-implemented method as paragraph K recites, wherein: the data item comprises an online form with a plurality of text boxes configured to receive a user to input information in the plurality of text boxes; and the first action comprises auto-filling known information into the plurality of text boxes.

M. The computer-implemented method as paragraph K recites, wherein: the data item comprises an electronic calendar invitation corresponding to a specified time, the electronic calendar invitation configured to receive a response from a user; and the first action comprises presenting an electronic calendar that is associated with the user indicating that the user is tentatively unavailable at the specified time.

N. The computer-implemented method as any of paragraphs J-M recite, further comprising: based at least in part on applying the trained model to the attributes, determining that the user action is likely to be a second action; and executing the second action as the default action.

O. The computer-implemented method as paragraph N recites, wherein: the data item comprises an electronic calendar invitation corresponding to a specified time, the electronic calendar invitation configured to receive a response from a user; and the second action comprises presenting an electronic calendar that is associated with the user indicating that the user is available at the specified time.

P. The computer-implemented method as any of paragraphs J-O recite, further comprising: receiving the user action; and overriding the default action with the user action.

Q. One or more computer-readable media encoded with instructions that, when executed by a processor, configure a computer to perform a method as any of paragraphs J-P recite.

R. A device comprising one or more processors and one or more computer readable media encoded with instructions that, when executed by the one or more processors, configure a computer to perform a computer-implemented method as recited in any of paragraphs J-P.

S. A system comprising: means for receiving attributes selected from a data item configured to receive user action, the data item associated with a default action that is implemented in an absence of the user action; means for applying a trained model to the attributes; means for, based at least in part on applying the trained model to the attributes, determining what the user action is likely to be; and means for, based at least in part on the determining, executing the default action in the absence of the user action.

T. The system as paragraph S recites, further comprising: means for, based at least in part on applying the trained model to the attributes, determining that the user action is likely to be a first action; and means for executing the first action as the default action.

U. The system as paragraph T recites, wherein: the data item comprises an online form with a plurality of text boxes configured to receive a user to input information in the plurality of text boxes; and the first action comprises auto-filling known information into the plurality of text boxes.

V. The system as paragraph T recites, wherein: the data item comprises an electronic calendar invitation corresponding to a specified time, the electronic calendar invitation configured to receive a response from a user; and the first action comprises presenting an electronic calendar that is associated with the user indicating that the user is tentatively unavailable at the specified time.

W. The system as any of paragraphs S-V recite, further comprising: means for, based at least in part on applying the trained model to the attributes, determining that the user action is likely to be a second action; and means for executing the second action as the default action.

X. The system as paragraph W recites, wherein: the data item comprises an electronic calendar invitation corresponding to a specified time, the electronic calendar invitation configured to receive a response from a user; and the second action comprises presenting an electronic calendar that is associated with the user indicating that the user is available at the specified time.

Y. The system as any of paragraphs S-X recites, further comprising: means for receiving the user action; and means for overriding the default action with the user action.

Z. A computer implemented method comprising: receiving data including user behavior data associated with a plurality of electronic calendar invitations associated with a user; selecting attributes based at least in part on the plurality of electronic calendar invitations; training a model based on the attributes to determine whether the user is likely to accept new electronic calendar invitations; and determining a set of rules using the model, the set of rules determining how the computing system is to respond to the new electronic calendar invitations.

AA. The computer-implemented method as paragraph Z recites, wherein the user behavior data indicates whether the user accepted individual electronic calendar invitations of the plurality of electronic calendar invitations, whether the user declined individual electronic calendar invitations of the plurality of electronic calendar invitations, and whether the user ignored individual electronic calendar invitations of the plurality of electronic calendar invitations.

AB. The computer-implemented method as either paragraph Z or AA recites, wherein the attributes correspond to one or more of content in the plurality of electronic calendar invitations, organizational data associated with the user, and organizational data associated with senders of the plurality of electronic calendar invitations.

AC. The computer-implemented method as any of paragraphs Z-AB recite, wherein determining how the computing system is to respond to the new electronic calendar invitations comprises: determining that the user is likely to accept a new electronic calendar invitation of the new electronic calendar invitations; and updating an electronic calendar to indicate that the user is tentatively unavailable on a specified time associated with the new electronic calendar invitation; or determining that the user is not likely to accept the new electronic calendar invitation; and updating the electronic calendar to indicate that the user is available at the specified time.

AD. A device comprising one or more processors and one or more computer readable media encoded with instructions that, when executed by the one or more processors, configure a computer to perform a computer-implemented method as recited in any of paragraphs Z-AC.

AE. One or more computer-readable media encoded with instructions that, when executed by a processor, configure a computer to perform a method as any of paragraphs Z-AC recite.

AF. A system comprising: means for receiving data including user behavior data associated with a plurality of electronic calendar invitations associated with a user; means for selecting attributes based at least in part on the plurality of electronic calendar invitations; means for training a model based on the attributes to determine whether the user is likely to accept new electronic calendar invitations; and means for determining a set of rules using the model, the set of rules determining how the computing system is to respond to the new electronic calendar invitations.

AG. The system as paragraph AF recites, wherein the user behavior data indicates whether the user accepted individual electronic calendar invitations of the plurality of electronic calendar invitations, whether the user declined individual electronic calendar invitations of the plurality of electronic calendar invitations, and whether the user ignored individual electronic calendar invitations of the plurality of electronic calendar invitations.

AH. The system as either paragraph AF or AG recites, wherein the attributes correspond to one or more of content in the plurality of electronic calendar invitations, organizational data associated with the user, and organizational data associated with senders of the plurality of electronic calendar invitations.

AI. The system as any of paragraphs AF-AH recite, wherein determining how the computing system is to respond to the new electronic calendar invitations comprises: determining that the user is likely to accept a new electronic calendar invitation of the new electronic calendar invitations; and updating an electronic calendar to indicate that the user is tentatively unavailable on a specified time associated with the new electronic calendar invitation; or determining that the user is not likely to accept the new electronic calendar invitation; and updating the electronic calendar to indicate that the user is available at the specified time.

### CONCLUSION

Although the subject matter has been described in language specific to structural features and/or methodological acts, it is to be understood that the subject matter defined in the appended claims is not necessarily limited to the specific features or acts described. Rather, the specific features and acts are described as illustrative forms of implementing the claims.

Conditional language such as, among others, “can,” “could,” “might” or “may,” unless specifically stated otherwise, are understood within the context to present that certain examples include, while other examples do not necessarily include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

What is claimed is:

1. A system comprising:
one or more processors; and
memory storing one or more modules that are executable by the one or more processors to perform operations comprising:
receiving an electronic calendar invitation for a meeting at a specified time;
determining that a user is likely to accept the electronic calendar invitation based at least in part on one or more trained models; and
presenting an electronic calendar that is associated with the user indicating that the user is tentatively unavailable on the specified date at the specified time.

2. The system as claim 1 recites, wherein the one or more modules are executable by the one or more processors to further perform operations comprising causing a notification to be presented at a predetermined time before the specified time.

3. The system as claim 1 recites, wherein the one or more modules are executable by the one or more processors to further perform operations comprising:
determining that the user is not likely to accept the electronic calendar invitation based at least in part on the one or more trained models; and
presenting the electronic calendar indicating that the user is available at the specified time.

4. The system as claim 3 recites, wherein the one or more modules are executable by the one or more processors to further perform operations comprising canceling a notification corresponding to the electronic calendar invitation that is to be presented at a predetermined time before the specified time.

5. The system as claim 1 recites, wherein the one or more modules are executable by the one or more processors to further perform operations comprising training the one or more trained models based at least in part on past behaviors of the user and one or more attributes.

6. The system as claim 5 recites, wherein the one or more attributes correspond to one or more of content in the plurality of electronic calendar invitations, data associated with the user, or data associated with other users who sent the plurality of electronic calendar invitations.

7. The system as claim 5 recites, wherein:
the one or more attributes correspond to content in the plurality of electronic calendar invitations; and
the content in the plurality of electronic calendar invitations comprises one or more of:
a location included in individual ones of the plurality of electronic calendar invitations;
a time included in individual ones of the plurality of electronic calendar invitations;
participants included in individual ones of the plurality of electronic calendar invitations; and
descriptive text in individual ones of the plurality of electronic calendar invitations.

8. The system as claim 5 recites, wherein:
the one or more attributes correspond to data associated with other users who sent the plurality of electronic calendar invitations; and
the data associated with the other users comprises at least one of:
departments of the other users;
job titles of the other users;
managers of the other users; or
numbers of employees who directly report to the other users.

9. The system as claim 5 recites, wherein:
the one or more attributes correspond to data associated with the user and data associated with other users who sent the plurality of electronic calendar invitations; and
the data associated with the user and the data associated with the other users is used to train the one or more trained models based at least in part on identifying at least one of a same department, same job title, or same manager between the user and the other users.

10. A computer-implemented method comprising:
receiving attributes selected from a data item configured to receive user action, the data item associated with a default action that is implemented in an absence of the user action;
applying a trained model to the attributes;
based at least in part on applying the trained model to the attributes, determining what the user action is likely to be; and
based at least in part on the determining, executing the default action in the absence of the user action.

11. The computer-implemented method as claim 10 recites, further comprising:
based at least in part on applying the trained model to the attributes, determining that the user action is likely to be a first action; and
executing the first action as the default action.

12. The computer-implemented method as claim 11 recites, wherein:
the data item comprises an online form with a plurality of text boxes configured to receive a user to input information in the plurality of text boxes; and
the first action comprises auto-filling known information into the plurality of text boxes.

13. The computer-implemented method as claim 11 recites, wherein:
the data item comprises an electronic calendar invitation corresponding to a specified time, the electronic calendar invitation configured to receive a response from a user; and
the first action comprises presenting an electronic calendar that is associated with the user indicating that the user is tentatively unavailable at the specified time.

14. The computer-implemented method as claim 10 recites, further comprising:
based at least in part on applying the trained model to the attributes, determining that the user action is likely to be a second action; and
executing the second action as the default action.

15. The computer-implemented method as claim 14 recites, wherein:
the data item comprises an electronic calendar invitation corresponding to a specified time, the electronic calendar invitation configured to receive a response from a user; and
the second action comprises presenting an electronic calendar that is associated with the user indicating that the user is available at the specified time.

16. The computer-implemented method as claim 10 recites, further comprising:
receiving the user action; and
overriding the default action with the user action.

17. A computer-implemented method comprising:
receiving data including user behavior data associated with a plurality of electronic calendar invitations associated with a user;
selecting attributes based at least in part on the plurality of electronic calendar invitations;
training a model based on the attributes to determine whether the user is likely to accept new electronic calendar invitations; and
determining a set of rules using the model, the set of rules determining how the computing system is to respond to the new electronic calendar invitations.

18. The computer implemented method as claim 17 recites, wherein the user behavior data indicates whether the user accepted individual electronic calendar invitations of the plurality of electronic calendar invitations, whether the user declined individual electronic calendar invitations of the plurality of electronic calendar invitations, and whether the user ignored individual electronic calendar invitations of the plurality of electronic calendar invitations.

19. The computer-implemented method as claim 17 recites, wherein the attributes correspond to one or more of content in the plurality of electronic calendar invitations, organizational data associated with the user, and organizational data associated with senders of the plurality of electronic calendar invitations.

20. The computer-implemented method as claim 17 recites, wherein determining how the computing system is to respond to the new electronic calendar invitations comprises:
determining that the user is likely to accept a new electronic calendar invitation of the new electronic calendar invitations; and
updating an electronic calendar to indicate that the user is tentatively unavailable on a specified time associated with the new electronic calendar invitation; or
determining that the user is not likely to accept the new electronic calendar invitation; and
updating the electronic calendar to indicate that the user is available at the specified time.
